(19) United States
(12) Patent Application Publication
(10) Pub. No.: US 2025/0106252 A1
(43) Pub. Date: Mar. 27, 2025

(54) METHOD FOR GENERATING A HONEYPOT

(71) Applicant: Robert Bosch GmbH, Stuttgart (DE)

(72) Inventors: Dominik Germek, Berlin (DE); Niclas Ilg, Ammerbuch (DE)

(21) Appl. No.: 18/884,197

(22) Filed: Sep. 13, 2024

(30) Foreign Application Priority Data
Sep. 21, 2023 (DE) 102023209246.8

(51) Int. Cl. H04L 9/40

(52) U.S. Cl. CPC H04L 63/1491

(57) ABSTRACT

A method for generating a honeypot for a target system. The method includes ascertaining services provided and protocols supported by a target system to be imitated via a network interface by sending queries to the target system for a plurality of services, ascertaining a honeypot type and a configuration for the selected honeypot type that, if configured with the selected configuration, can provide the ascertained services and support the ascertained protocols, and generating a honeypot from the ascertained honeypot type with the ascertained configuration.

### FIELD

The present invention relates to a method for generating a honeypot.

### BACKGROUND INFORMATION

The number of networked data processing devices (including embedded devices) is increasing rapidly. An important aspect of all these devices—be they server computers on the Internet or control devices in the automotive or IoT sector—is product security. Honeypots are dummies that imitate such a valuable (target) system in order to attract attackers and gain information about their attack strategies and targets. Honeypots are an established tool for threat analysis, especially in corporate IT, and they are now also used in the area of the (industrial) Internet of Things ((I)IoT). Although honeypots are a very useful tool to complement the cybersecurity strategy, implementing honeypots for the specific needs and the relevant target system requires a lot of manual work by experts. Therefore, approaches that enable easier provision (in particular configuration) of a suitable honeypot for a given target system are desirable.

### SUMMARY

According to various embodiments of the present invention, a method for generating a honeypot for a (predefined) target system is provided, comprising ascertaining services provided and protocols supported by a target system to be imitated via a network interface by sending queries to the target system for a plurality of services (e.g., queries for a port scan such as service queries, synchronization packets, NULL packets, fin scan packets, etc., to which the target system responds, if applicable), ascertaining a honeypot type (e.g., a honeypot architecture) and a configuration for the selected honeypot type that, if configured with the selected configuration, can provide the ascertained services and support the ascertained protocols, and generating a honeypot of the ascertained honeypot type with the ascertained configuration.

The method described above allows for the automatic generation of a honeypot with low interaction for a black-box target system, thus, e.g., without requiring source code of the software running on the target system.

Automatic generation (including automatic configuration) is not limited to specific network services or protocols. The black-box approach, as described in the method described above, allows for a derivation without access to the source code or the internal structure of the target system. Only network access to the target system is required. This makes it possible to offer honeypot services to operators of target systems who do not want to reveal the inner workings of their (target) systems. The black-box approach ensures that honeypots can be derived without prior specialized knowledge about the honeypot structure and device specifics.

Since the generation of the honeypot is based on knowledge gained by viewing (scanning) the target system from the outside (and, e.g., without knowledge of the internal function or structure of the target system (if it cannot be deduced from the results of the scanning)), the above approach can be viewed as a black-box generation of a honeypot.

Various exemplary embodiments of the present invention are specified below.

Exemplary embodiment 1 is a method for generating a honeypot (for a predefined target system) as described above.

Exemplary embodiment 2 is the method according to exemplary embodiment 1, wherein at least a portion of the queries are port scan packets.

The carrying out of a port scan allows for effective ascertainment of supported services and the protocols used therefor.

Exemplary embodiment 3 is the method according to exemplary embodiment 1 or 2, wherein a secrecy criterion is checked for information about the target system and the honeypot is generated in such a way that it does not include information to be kept secret according to the secrecy criterion.

Thus, the honeypot generating device can filter information obtained (by scanning, i.e., sending queries, or from other sources) and generate the honeypot based on the filtered information (i.e., without the filtered-out information).

Exemplary embodiment 4 is the method according to one of the exemplary embodiments 1 to 3, wherein based on the ascertained services provided and the protocols supported by the target system to be imitated, a Boolean expression is ascertained which the honeypot is to fulfill and the honeypot type and the configuration are ascertained such that the Boolean expression is fulfilled.

This allows for efficient and automatic selection (e.g., by appropriate parsing of the Boolean expression by a selection tool running on the honeypot generating device, i.e., e.g., selecting a honeypot type from a honeypot library and ascertaining a configuration therefor) of the honeypot type and configuration.

Exemplary embodiment 5 is a data processing system with a honeypot generating device that is configured to carry out the method according to one of exemplary embodiments 1 to 4.

Exemplary embodiment 6 is a computer program comprising commands which, when executed by a processor, cause the processor to carry out a method according to one of exemplary embodiments 1 to 4.

Exemplary embodiment 7 is a computer-readable medium storing commands which, when executed by a processor, cause the processor to carry out a method according to one of exemplary embodiments 1 to 4.

In the figures, similar reference signs generally refer to the same parts throughout the various views. The figures are not necessarily true to scale, with emphasis instead generally being placed on the representation of the principles of the present invention. In the following description, various aspects of the present invention are described with reference to the figures.

### BRIEF DESCRIPTION OF THE DRAWINGS

FIG. 1 shows a computer network, according to an example embodiment of the present invention.

FIG. 2 illustrates the generation of a honeypot according to one example embodiment of the present invention.

FIG. 3 shows a flowchart illustrating a method for generating a honeypot for a target system according to one example embodiment of the present invention.

### DETAILED DESCRIPTION OF EXAMPLE EMBODIMENTS

The following detailed description relates to the accompanying figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

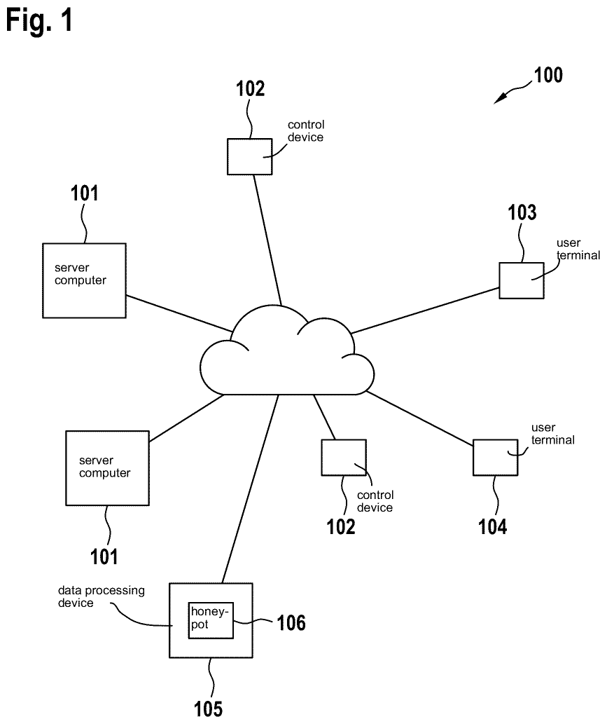

FIG. 1 shows a computer network 100. The computer network 100 includes a plurality of data processing devices 101-105, which are interconnected by communication links 106. The data processing devices 101-105 include, e.g., server computers 101 and control devices 102 along with user terminals 103, 104.

Server computers 101 provide various services, such as Internet sites, banking portals, etc. A control device 102 is, e.g., a control device for a robot device such as a control device in an autonomous vehicle. The server computers 101 and control devices 102 thus fulfill different tasks and typically a server computer 101 or a control device 102 can be accessed from a user terminal 103, 104. This is particularly the case if a server computer 101 offers a functionality to a user, such as a banking portal. However, a control device 102 can also allow access from outside (e.g., so that it can be configured). Depending on the task of a server computer 101 or control device 102, they can store security-related data and execute security-related tasks. Accordingly, they must be protected against attackers. For example, an attacker using one of the user terminals 104 could, through a successful attack, gain possession of secret data (such as keys), manipulate accounts or even manipulate a control device 102 in such a way that an accident occurs.

A security measure against such attacks is a so-called honeypot 106 (which is implemented by one of the data processing devices 105). It seemingly provides a functionality and thus serves as bait to attract potential attackers. However, it is isolated from secret information or critical functionality, so that attacks thereon are effected in a controlled environment and the risk of compromising the actual functionality is minimized. In this way, it makes it possible to gain knowledge about attacks on a target system (e.g., one of the server computers 101 or one of the control devices 102)—and thus the threat landscape—to which a response can be made by the implementation of suitable measures on the target system, without these attacks endangering the target system.

Gaining insight into the threat landscape in relation to a specific device or product is a challenging task. Putting a real system in the hands of attackers to examine the attack path can provide a lot of information. However, sacrificing a real device is often not an option—such environments could be abused for later attacks or are expensive to maintain in large numbers. A honeypot is a computer program that imitates a target system (i.e., typically a “valuable” device) in order to attract attackers. Low-interaction honeypots only imitate network-related services and monitor connection or login attempts. Honeypots are being used in enterprise IT and the Internet of Things (IoT), and the increasing number of connected devices in the automotive sector indicates a similar trend. While low-interaction honeypots are a useful tool to monitor (malicious) interest in a specific device, generating honeypots for different devices is laborious.

According to various embodiments, an approach is therefore provided that allows automatically ascertaining a suitable honeypot (i.e., e.g., a suitable honeypot architecture and configuration therefor) that mimics the target system. This is achieved by a honeypot generating device scanning the target system from the outside and thus ascertaining externally visible properties of the target system, in particular services offered via the network interface and supported protocols thereof, and generating a honeypot accordingly. Thus, according to various embodiments, a low-interaction honeypot can be efficiently generated for a target system without manual implementation.

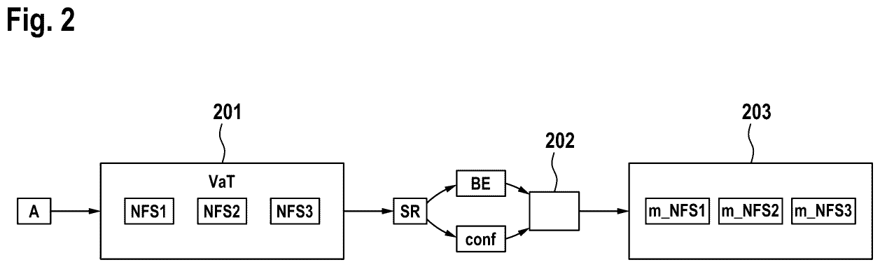

FIG. 2 illustrates the generation of a honeypot according to one embodiment.

Selecting a honeypot architecture and ascertaining a configuration therefor is effected by a honeypot generating device (which implements a “honeypot agent” A), which corresponds, for example, to one of the user terminals 104 (e.g., a computer with which a user (such as a system administrator) configures the honeypot 106 and instructs the data processing device 105 to provide the honeypot 106 thus configured).

First, the honeypot agent A scans the target system 201, in FIG. 2 denoted by “VaT” (for “valuable target”), from the outside (i.e., via the network interface of the target system 201, i.e., what is visible via the network interface). It recognizes all services NFSx of the target system 201 that are directed to the outside (i.e., the other data processing devices of the computer network 100), i.e., offered, and creates a scan result SR. From this scan result, the honeypot agent A forms a Boolean expression BE that includes the requirements for the honeypot to be generated (e.g., which services and/or protocols the honeypot should support, because these were recognized during scanning; i.e., the recognized services are converted into a Boolean expression). The honeypot agent A selects a suitable honeypot 202 (i.e., a suitable honeypot architecture, thus a suitable honeypot “type,” e.g., a specific version number) that fulfills the Boolean expression BE. For example, the honeypot will be selected based on the services and/or protocols offered thereby. The honeypot agent A also uses the scan result to derive a configuration conf with which the selected honeypot 202 is configured.

The honeypot 203 is then generated (e.g., by appropriate instructions from the honeypot generating device to the data processing device 105). According to its architecture (i.e., its type) 202 and its configuration, it offers the (network) services m_NFSx detected in the scan, which imitate the services running on the target system 201 (and offered thereby).

Scanning the target system by the honeypot agent A can be done with the aid of network and vulnerability scanners such as Nmap and OpenVas. Such scanners typically attempt to recognize the specific version of a network protocol in order to look for known security vulnerabilities. In the present case, the information obtained in this way can be used to select and configure the honeypot (including its services).

The selection of the honeypot (or a plurality of honeypots) is effected, as explained above, on the basis of a Boolean expression, which includes all the properties that the honeypot should fulfill. For example, a Boolean expression for a honeypot capable of imitating MQTT, OpenSSH version 7.1 and HTTP has the following form:

MQTT AND (OpenSSH_V7.1 OR SSH_configurable) AND http.

A honeypot (i.e., the honeypot architecture or honeypot type), the properties of which evaluate the expression as true, is selected as a suitable honeypot.

When the honeypot agent A has selected a honeypot, it creates the configuration conf for the selected honeypot, such that the configuration includes all the details of the services to be imitated (or the services fulfill them). These include, for example, the network port on which the service runs, the banners and headers that identify the service to the outside world, along with protocol specifics (e.g., permitted login attempts). The configuration can be created in any suitable text format, such as JSON, yaml or XML. A possible configuration for HTTP is the following:

conf HTTP:
network_port: 80
banner: “Apache/2”
headers: {“X-XSS-Protection”: “1”, “X-Frame-Options”:
“SAMEORIGIN”, “X-Content-Type-Options”: “nosniff”,
“Set-Cookie”:
“PHPSESSID=iads7sadj223jh; path=/; secure;
HttpOnly” }

The honeypot agent ascertains all information in the configuration when scanning the target system 201. As a result, the honeypot 203 (in particular the services imitated thereby) can be configured such that the honeypot 203 exactly imitates the scanned target system.

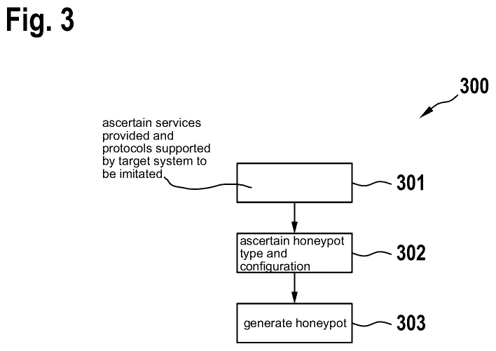

In summary, according to various embodiments, a method is provided as shown in FIG. 3.

FIG. 3 shows a flowchart illustrating a method for generating a honeypot for a (predefined) target system according to one embodiment.

In 301, services provided and protocols supported by a target system to be imitated via a network interface are ascertained by sending queries to the target system for a variety of services (e.g., queries for a port scan such as service queries, synchronization packets, NULL packets, fin-scan packets, etc., to which the target system responds, if applicable).

In 302, a honeypot type (e.g., a honeypot architecture) and a configuration for the selected honeypot type are ascertained which (i.e., such that the honeypot type), if configured with the selected configuration, can provide the ascertained services and support the ascertained protocols.

In 303, a honeypot of the ascertained honeypot type with the ascertained configuration is generated (i.e., by configuring the ascertained honeypot type with the ascertained configuration).

The method of FIG. 3 can be carried out by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g., implemented) by a data processing unit by one or more special functions that are performed by the data processing unit.

The method is therefore in particular computer-implemented according to various embodiments.

1-7. (canceled)

8. A method for generating a honeypot for a target system, comprising the following steps:
ascertaining services provided and protocols supported by a target system to be imitated via a network interface by sending queries to the target system for a plurality of services;
ascertaining a honeypot type and a configuration for the selected honeypot type that, when configured with the ascertained configuration, can provide the ascertained services and support the ascertained protocols; and
generating a honeypot of the ascertained honeypot type with the ascertained configuration.

9. The method according to claim 8, wherein at least a portion of the queries are port scan packets.

10. The method according to claim 8, wherein a secrecy criterion is checked for information about the target system and the honeypot is generated in such a way that it does not include information to be kept secret according to the secrecy criterion.

11. The method according to claim 8, wherein based on the ascertained services provided and the ascertained protocols supported by the target system to be imitated, a Boolean expression is ascertained which the honeypot is to fulfill and the honeypot type and the configuration are ascertained such that the Boolean expression is fulfilled.

12. A data processing system with a honeypot generating device which is configured to generate a honeypot for a target system, the honeypot generatin device configured to:
ascertaini services provided and protocols supported by a target system to be imitated via a network interface by sending queries to the target system for a plurality of services;
ascertain a honeypot type and a configuration for the selected honeypot type that, when configured with the ascertained configuration, can provide the ascertained services and support the ascertained protocols; and
generate a honeypot of the ascertained honeypot type with the ascertained configuration.

13. A non-transitory computer-readable medium on which are stored commands for generating a honeypot for a target system, the commands, when executed by a processor, causing the processor to perform the following steps:
ascertaining services provided and protocols supported by a target system to be imitated via a network interface by sending queries to the target system for a plurality of services;
ascertaining a honeypot type and a configuration for the selected honeypot type that, when configured with the ascertained configuration, can provide the ascertained services and support the ascertained protocols; and
generating a honeypot of the ascertained honeypot type with the ascertained configuration.
